(19) United States
(12) Patent Application Publication
(10) Pub. No.: US 2012/0049853 A1
(43) Pub. Date: Mar. 1, 2012

(54) BATTERY CAPACITY TEST APPARATUS

(75) Inventors: LING-YU XIE, Shenzhen City (CN); XING-PING XIE, Shenzhen City (CN)

(73) Assignees: HON HAI PRECISION INDUSTRY CO. LTD., Tu-Cheng (TW); HONG FU JIN PRECISION INDUSTRY (ShenZhen) CO.,LTD., Shenzhen City (CN)

(21) Appl. No.: 12/970,074

(22) Filed: Dec. 16, 2010

(30) Foreign Application Priority Data
Aug. 24, 2010 (CN) 201010261577.X

(51) Int. Cl. G01N 27/416

(52) U.S. Cl. 324/433; 324/427

(57) ABSTRACT

A battery capacity test apparatus for indicating capacity of a battery includes a voltage regulator module, a comparator module, and an indication module. The voltage regulator module is configured to receive a voltage signal from the battery, and output a plurality of decreased sub-voltages. The comparator module is configured to receive the plurality of decreased sub-voltages, and compare the plurality of decreased sub-voltages with a reference voltage to output control signals. The indication module is configured to receive the control signals, and indicate capacity of the battery according to the control signals.

### BACKGROUND

1. Technical Field

The disclosure generally relates to a test apparatus, especially to a battery capacity test apparatus.

2. Description of Related Art

Electronic devices such as mobile phones and notebooks require high quality storage batteries, which must be tested before use. While capacity of the batteries needs to be determined, many test methods require special apparatus, which is expensive and increases costs.

Therefore there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a battery capacity test apparatus.

FIG. 2 is a circuit view of an embodiment of the battery capacity test apparatus of FIG. 1.

FIG. 3 is a circuit view of a comparator chip of FIG. 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

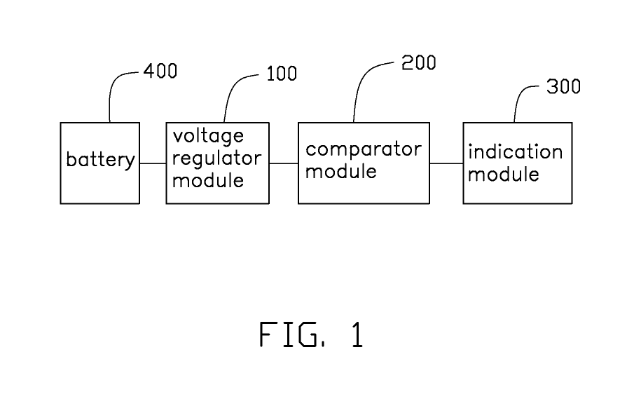

Referring to FIG. 1, an embodiment of a battery capacity test apparatus for a battery 400 includes a voltage regulator module 100, a comparator module 200 and an indication module 300. The voltage regulator module 100 is configured to receive a voltage signal from the battery 400, and output a plurality of decreased sub-voltages. The comparator module 200 is configured to receive the plurality of sub-voltages for comparison with a reference voltage to output control signals. The indication module 300 is configured to receive the control signals, and indicate capacity of the battery 400 according thereto.

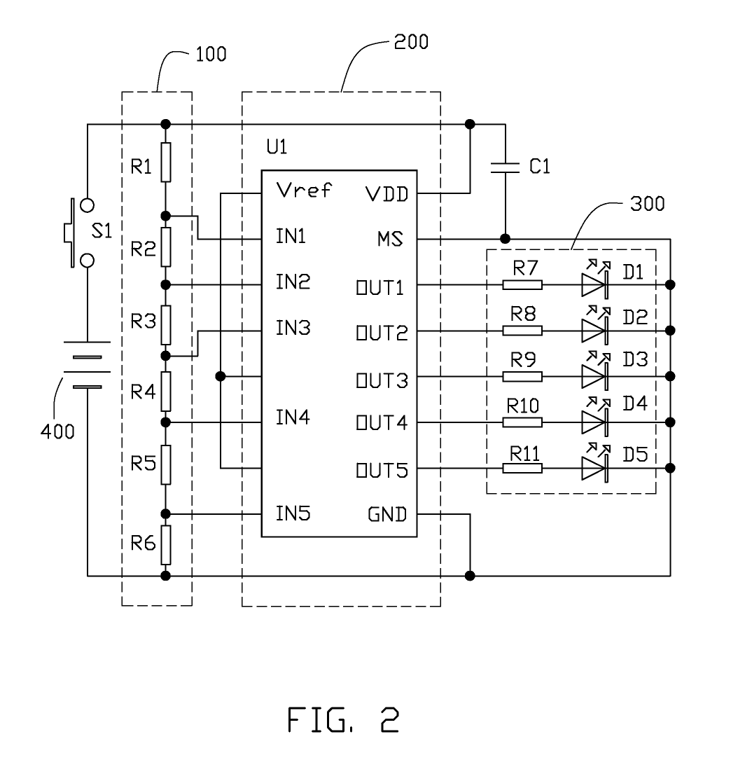

Referring to FIG. 2, the voltage regulator module 100 includes a plurality of resistors R1˜R6 serially connected. The serial resistors R1˜R6 are electrically connected between anode and cathode of the battery 400 by a switch S1. A plurality of connection points between the plurality of resistors R1˜R6 outputs the plurality of sub-voltages respectively. In one embodiment, resistances of the plurality of resistors R1˜R6 are 2.5 kiloΩ, 22.6Ω, 52Ω, 34.8Ω, 33Ω, and 1.25 kiloΩ respectively.

The comparator module 200 includes a comparator chip U1. The comparator chip U1 includes a plurality of input terminals IN1˜IN5, output terminals OUT1˜OUT5, a reference terminal Vref, a power terminal VDD and a ground terminal GND. The input terminals IN1˜IN5 are electrically connected to the plurality of connection points between the plurality of resistors R1˜R6 respectively. The comparator chip U1 is configured to output the control signals by the plurality of output terminals OUT1˜OUT5 according to comparison results. The reference terminal Vref is configured to output the reference voltage. The power terminal VDD is electrically connected to the ground terminal GND via a capacitor C1. In one embodiment, the capacity of the battery 400 is 3.7V˜4.2V when fully charged. The reference voltage is 1.25 V.

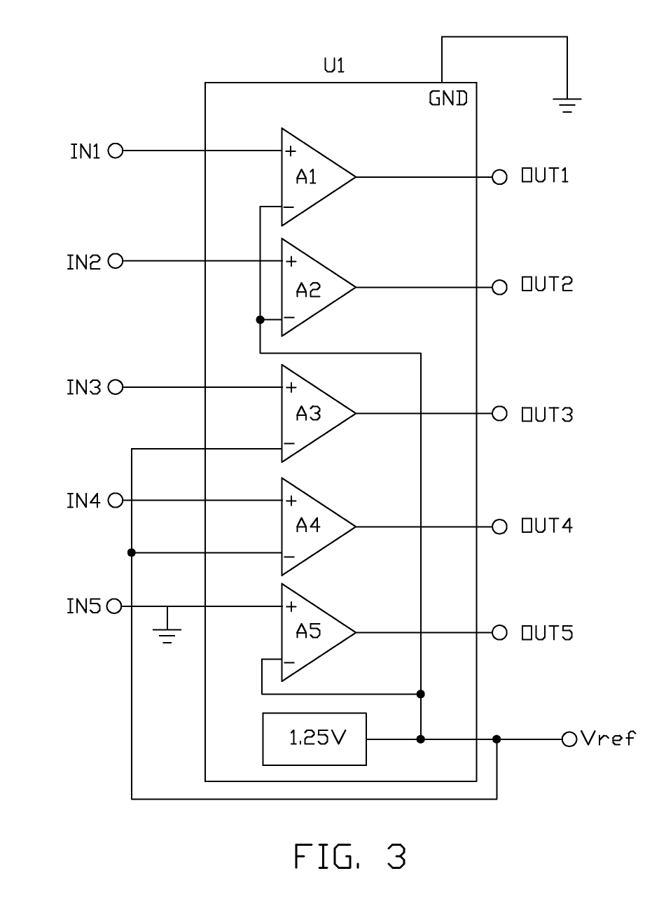

Referring to FIG. 3, the comparator chip U1 includes a plurality of comparators A1˜A5. Non-inverting input terminals of the plurality of comparators A1˜A5 are configured to act as the plurality of input terminals IN1˜IN5. Inverting input terminals of the plurality of comparators A1˜A5 are electrically connected to act as the reference terminal Vref. Output terminals of the plurality of comparators A1˜A5 are configured to act as the plurality of output terminals OUT1˜OUT5.

The indication module 300 includes a plurality of LEDs D1˜D5 and resistors R7˜R11. Anodes of the plurality of LEDs D1˜D5 are electrically connected to the plurality of output terminals OUT1˜OUT5 by the plurality of resistors R7˜R11 respectively. Cathodes of the plurality of LEDs D1˜D5 are grounded.

In use, the switch S1 is activated, and the voltage regulator module 100 receives the voltage signal from the battery 400 and outputs the plurality of sub-voltages via the plurality of connection points between the plurality of resistors R1˜R6. The plurality of input terminals IN1˜IN5 receives the plurality of sub-voltages. The comparator chip U1 compares the plurality of sub-voltages with the 1.25V reference voltage and outputs the control signals via the plurality of output terminals OUT1˜OUT5 according to the comparison results. When the plurality of sub-voltages received by the plurality of input terminals IN1˜IN5 exceed the 1.25V reference voltage, the comparator chip U1 outputs high voltage level control signals to the plurality of LEDs D1˜D5 by the corresponding output terminals OUT1˜OUT5. The corresponding LEDs D1˜D5 emit light. When the plurality of sub-voltages received by the plurality of input terminals IN1˜IN5 are less than the 1.25V reference voltage, the comparator chip U1 outputs low voltage level control signals to the plurality of LEDs D1˜D5 by the corresponding output terminals OUT1˜OUT5. The corresponding LEDs D1˜D5 do not emit light.

When the battery 400 is full, the plurality of LEDs D1˜D5 emits light; when the battery 400 is 80% full, the LED D5 does not emit light; and the LEDs D1˜D4 emit light; when the battery 400 is 60% full, the LEDs D5 and D4 do not emit light and the LEDs D1˜D3 emit light; when the capacity of the battery 400 is 40% full, the LEDs D5˜D3 do not emit light; and the LEDs D1 and D2 emit light; when the battery 400 is 20% full, the LEDs D5˜D2 do not emit light; and the LED D1 emits light; and when the capacity of the battery 400 is empty, none of the plurality of LEDs D1˜D5 emit light.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A battery capacity test apparatus, comprising:
a voltage regulator module configured to receive a voltage signal from the battery, and output a plurality of decreased sub-voltages;
a comparator module configured to receive the plurality of decreased sub-voltages, compare the plurality of decreased sub-voltages with a reference voltage, and output control signals; and
an indication module configured to receive the control signals, and indicate capacity of the battery according to the control signals.

2. The battery capacity test apparatus of claim 1, wherein the voltage regulator module comprises a plurality of resistors serially connected together; the plurality of resistors are electrically connected between anode and cathode of the battery; and a plurality of connection points between the plurality of resistors are configured to output the plurality of decreased sub-voltages respectively.

3. The battery capacity test apparatus of claim 2, wherein the comparator module comprises a comparator chip; the comparator chip comprises a plurality of input terminals and a plurality of output terminals; the plurality of input terminals are electrically connected to the plurality of connection points between the plurality of resistors respectively to receive the plurality of sub-voltages; and the comparator chip is configured to output the control signals by the plurality of output terminals according to comparison results of the plurality of sub-voltages.

4. The battery capacity test apparatus of claim 3, wherein the comparator chip further comprises a power terminal and a ground terminal; and the power terminal is electrically connected to the ground terminal by a capacitor.

5. The battery capacity test apparatus of claim 3, wherein the indication module comprises a plurality of LEDs and resistors; anodes of the plurality of LEDs are electrically connected to the plurality of output terminals of the comparator chip correspondingly; and cathodes of the plurality of LEDs are grounded.

6. The battery capacity test apparatus of claim 5, wherein when the plurality of decreased sub-voltage received by the plurality of input terminals of the comparator chip exceed the reference voltage, the comparator chip outputs high voltage level control signals to the plurality of LEDs by the corresponding output terminals; and the corresponding LEDs emit light.

7. The battery capacity test apparatus of claim 5, wherein when the plurality of decreased sub-voltage received by the plurality of input terminals of the comparator chip are less than the reference voltage, the comparator chip outputs low voltage level control signals to the plurality of LEDs by the corresponding output terminals and the corresponding LEDs do not emit light.

8. A battery capacity test apparatus, comprising:
a voltage regulator module configured to receive a voltage signal from the battery, and output a plurality of decreased sub-voltages;
a comparator module configured to receive the plurality of decreased sub-voltages, and compare the plurality of sub-voltages with a reference voltage to output control signals; and
an indication module configured to receive the control signals and indicate capacity of the battery according to the control signals; wherein when a sub-voltage exceeds the reference voltage, the comparator module is configured to output a control signal and drive the indication module to indicate; and when the sub-voltage is less than the reference voltage, the comparator module is configured to output the control signal and drive the indication module not to indicate capacity of the battery.
